(19) United States
(12) Patent Application Publication
(10) Pub. No.: US 2019/0001527 A1
(43) Pub. Date: Jan. 3, 2019

(54) EXTRUDER COMPRISING A DEFLECTION ELEMENT FOR TARGETED FLOW AGAINST PERFORATED PLATE REGIONS

(71) Applicant: BASF SE, Ludwigshafen am Rhein (DE)

(72) Inventor: Andreas LOHSE, Huede (DE)

(73) Assignee: BASF SE, Ludwigshafen am Rhein (DE)

(21) Appl. No.: 16/064,880

(22) PCT Filed: Dec. 12, 2016
(86) PCT No.: PCT/EP2016/080615

§ 371 Date: Jun. 21, 2018

(30) Foreign Application Priority Data
Dec. 22, 2015 (DE) 10 2015 226 512.9

(51) Int. Cl. B29B 9/02; B29C 47/00; B29C 47/08; B29C 47/12; B29C 47/70; B29C 47/92

(52) U.S. Cl. CPC B29B 9/02; B29C 47/0066; B29C 47/0866; B29C 47/122; B29C 2947/92571; B29C 47/92; B29C 2947/92019; B29C 2947/924; B29C 47/702

(57) ABSTRACT

The invention relates to an extruder comprising a housing having a flow channel (1) for a melt and a perforated plate (2) delimiting the flow channel (1) on the outlet side, wherein an inlet flow element (3) having passage areas (4) and covering surfaces (5) is arranged so as to be movable ahead of the perforated plate (2) in the direction of flow of the melt in such a way that, when the inlet flow element (3) is moved, a first subset of holes in the perforated plate (2) is exposed and a second subset of holes in the perforated plate (2) is closed, wherein the covering surfaces (5) extend radially from the center of the inlet flow element (3) to the rim thereof.

The invention relates to an extruder comprising a housing having a flow channel for a melt and a perforated plate delimiting the flow channel on the outlet side.

Extruders and perforated plates of the type in question are known from the literature. Thus, document DE 35 32 937 A1 describes a perforated plate which is secured on the outlet end of an extruder and is suitable for underwater granulation of extruded plastics, for example.

In conventional production processes, e.g. those for producing plastic granules, heated material such as a polymer melt is passed through a flow channel in the housing of an extruder and forced through openings in the perforated plate at the outlet. As the process progresses, deposits and adhesions form in the openings of the perforated plate until finally the open cross sections have been reduced to such an extent that the perforated plate must be cleaned or exchanged. When cleaning in continuous operation, this is inevitably associated with a loss of material. When exchanging the perforated plate, the plant must be shut down, leading to downtimes and associated losses of capacity.

In order to counteract the losses of material and capacity, filter screens that are inserted exchangeably within the extruder in the path of the flow ahead of the perforated plate are known. Thus, DE 30 13 038 A1 discloses a screen changing device for extruders for the continuous processing of melted plastics, in which a changeover slide that can be moved transversely to the flow channel for the melt is provided in a location hole in the extruder housing.

In DE 28 11 771 A1, a description is given of a filter screen changing device for a synthetic resin extruder, in which the flow path within the extruder is divided into two parallel subchannels. Before the outlet from the extruder, the two subchannels are reunited to form a single outlet channel. In each of the two subchannels there is a movable plate, half of which is of solid construction without apertures and the other half has a hole with an inserted filter screen. The plates are positioned in such a way that, during operation, one subchannel in each case is shut off by the solid part of a plate and the plastic melt flows through the filter screen situated in the other sub-channel. To clean the filter screens, the positions of the plates are reversed, so that the previously open channel is then closed and the melt then flows through the previously closed channel. The contaminated filter screen is then situated outside the extruder housing and can be exchanged or cleaned.

The object was to develop an extruder of the type in question in such a way that production-related losses of material and downtimes can be reduced further than in the prior art.

According to the invention, this object is achieved by an extruder comprising a housing having a flow channel for a melt and a perforated plate delimiting the flow channel on the outlet side, wherein an inlet flow element having passage areas and covering surfaces is arranged so as to be movable ahead of the perforated plate in the direction of flow of the melt in such a way that, when the inlet flow element is moved, a first subset of holes in the perforated plate is exposed and a second subset of holes in the perforated plate is closed, wherein, in a preferred embodiment, the covering surfaces (5) extend radially from the center of the inlet flow element (3) to the rim thereof.

In the context of the invention, a perforated plate is taken to be the component out of which the melt leaves the extruder before it is fed to further processing. Filtering or screening devices that may optionally be present within the extruder are not “perforated plates” in the sense according to the invention.

The inlet flow element is used to direct melt flowing in the direction of the extruder outlet to pre-determined regions of the perforated plate. For this purpose, the inlet flow element comprises passage areas, through which the melt can flow, and covering surfaces, which prevent the melt from flowing onto regions of the perforated plate that are situated behind the covering surfaces in the direction of flow.

In an advantageous embodiment, the inlet flow element has an inlet flow cone, the base of which faces in the direction of the perforated plate and which tapers conically counter to the direction of flow of the melt. In this context, the term “cone” should not be taken in a strictly mathematical sense. In the sense according to the invention, the inlet flow cone can have the form of a cone, a truncated cone or some other shape that tapers counter to the direction of flow of the melt. In this case, the base can be circular or elliptical or polygonal, for example. An inlet flow cone of this kind directs the approaching melt radially sideways onto the through-flow areas and covering surfaces and can thus be used for uniform distribution of the melt.

The movement of the inlet flow element can take place laterally or rotationally, for example, as long as different subsets of holes in the perforated plate are exposed and closed in the process. In another preferred embodiment, the inlet flow element has a circular cross-sectional area, and the movement is accomplished by rotation about the center of the cross-sectional area. Depending on the number, size and geometry of the passage areas and covering surfaces and of the angle provided for rotation, subsets of holes in the perforated plate can be exposed and closed completely or partially.

The number, size and geometry of the passage areas and of the covering surfaces can be configured differently and matched to the requirements and circumstances in the specific case. In a preferred embodiment, the covering surfaces extend radially from the center of the inlet flow element to the rim thereof. The covering surfaces preferably become wider in a radial direction towards the rim as the circumferential distance from the center to the rim increases. It is furthermore preferred that the covering surfaces have a profile in longitudinal section which has its widest extent at the base facing the perforated plate and tapers counter to the direction of flow of the melt. A profile of this kind has the advantage that melt flowing onto the covering surface is directed away from the covering surface towards the edges thereof and thus onto the adjacent passage areas.

In another advantageous embodiment, the covering surfaces are in contact with the perforated plate at least with their edges. On the one hand, this avoids a situation where some of the melt can pass between the covering surface and the surface of the perforated plate and under the covering surface, thus ensuring that the melt can only flow through the passage areas provided for this purpose. On the other hand, the edges of the covering surfaces in an embodiment of this kind can, as it were, be used as strippers in order, during the movement, to scrape off any material that may adhere to the surface of the perforated plate, thereby preventing premature blockage of the openings in the perforated plate.

The movement of the inlet flow element can be accomplished manually, optionally with the aid of tools such as levers. The movement is preferably accomplished by using auxiliary power, e.g. electric, pneumatic or hydraulic auxiliary power. As a particularly preferred option, the movement of the inlet flow element is accomplished with the aid of an actuator.

In an advantageous embodiment, there is at least one sensor in or on the housing of the extruder, said sensor being suitable for detecting information on the pressure in the flow channel.

From the information on the pressure in the flow channel, it is possible to obtain information on the degree of blockage of the through-flow area that is in use.

In a preferred embodiment, this information is transmitted to an indicator by means of a device for electronic data transfer. The indicator can be in the immediate vicinity of the extruder in order, for example, to draw attention optically and/or acoustically to imminent blockage of the perforated disc, for example. However, the indicator can also be spatially remote from the extruder, e.g. in the form of an optically and/or acoustically perceptible indication in a process control system.

In a preferred embodiment, the extruder according to the invention has an actuator for moving the inlet flow element, at least one sensor for detecting a pressure in the flow channel and a control module, wherein the control module is designed in such a way that the inlet flow element is moved with the aid of the actuator when a predetermined critical value for the pressure or for a pressure difference is reached.

In an advantageous embodiment, the sensor is arranged and designed in such a way that the absolute pressure in the flow channel is determined. In another advantageous embodiment, at least two sensors are provided, which are arranged and designed in such a way that a pressure difference is determined. The predetermined critical value for the pressure or for the pressure difference is preferably matched to the respective melt being processed and to the corresponding process conditions. When detecting the absolute pressure as the critical value, it is thus possible, for example, to specify a pressure which is lower by a certain amount than the pressure at which safety devices, such as a safety valve or a shutdown valve, are triggered.

The control module can be implemented in a known manner, e.g. as a separate microcontroller, integrated into the actuator or as a module in a process control system.

Compared with known apparatus, the apparatus according to the invention has the advantage that the production time between two extruder shutdowns required for cleaning is significantly extended. Thus, when the covering surfaces and passage areas are divided up equally for example, the running time of the extruder is doubled since, after the first subset of holes in the perforated plate has been clogged, there is still a second subset comprising clean holes available. Another advantage is that the subsets of holes can be configured differently, making it possible to switch between two different product grades or between different production methods by moving the inlet flow element. In each case, the availability of the plant is significantly increased by means of the apparatus according to the invention, thereby increasing capacity and avoiding loss of material.

The invention is explained in greater detail below with reference to the drawings. The drawings should be understood as schematic illustrations. They do not represent a restriction of the invention, in respect of specific dimensions or variant embodiments for example.

### LIST OF REFERENCE SIGNS USED

1 . . . flow channel
2 . . . perforated plate
3 . . . inlet flow element
4 . . . passage area(s)
5 . . . covering surface(s)
6 . . . inlet flow cone
7 . . . actuator
8 . . . through-flow area(s) of the perforated plate
9 . . . first plate
10 . . . second plate
11 . . . seal
12 . . . granulating tool

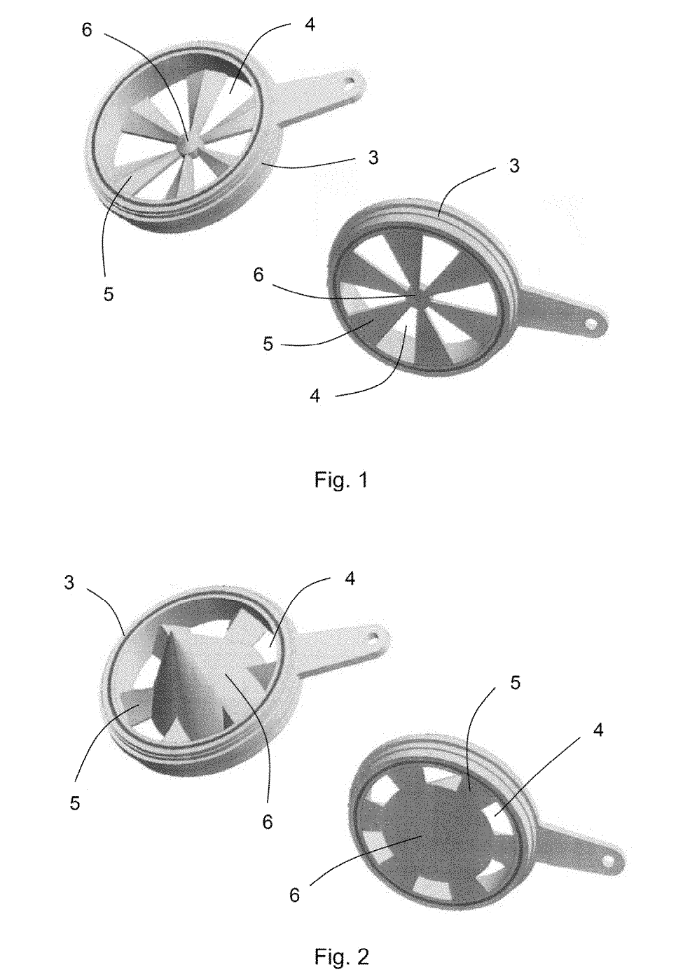

FIG. 1 shows a first preferred embodiment of an inlet flow element 3 for use in an extruder. The illustration at the top left corresponds to the view in the direction of flow of the melt, while the illustration at the bottom right corresponds to the view from the opposite direction, starting from the perforated plate. The inlet flow element 3 has a circular cross-sectional area and, at its rim, has an extension, which is provided for the purpose of moving the inlet flow element 3. In the middle of the cross-sectional area there is an inlet flow cone 6, the base of which faces in the direction of the perforated plate and which tapers counter to the direction of flow of the melt.

Starting from the inlet flow cone 6, which is in the center of the inlet flow element 3, six covering surfaces 5 extend radially outwards to the rim of the inlet flow element 3. Between the covering surfaces 5 there are open regions, which form the passage areas 4 for the melt.

In the example shown, the covering surfaces 5 become wider in a radial direction towards the rim as the circumferential distance from the center to the rim increases. The bases of the covering surfaces 5 are dimensioned in such a way that they correspond to the passage areas 4. In longitudinal section (perpendicularly to the cross-sectional area), the covering surfaces 5 have a profile which has its widest extent at the base facing the perforated plate and tapers counter to the direction of flow of the melt. Melt impinging upon the inlet flow element 3 is thus, on the one hand, directed away from the center by the conical shape of the inlet flow cone 6 and, on the other hand, guided away from the covering surfaces 5 to the edges of the covering surfaces 5 by virtue of the shaping of said surfaces and thus guided onto the adjacent passage areas 4.

FIG. 2 shows another preferred embodiment of an inlet flow element 3 for use in an extruder. This embodiment differs from that shown in FIG. 1 only in the geometrical configuration of the inlet flow cone 6 and of the covering surfaces 5. The inlet flow cone 6 is significantly larger in diameter and in axial extent than the embodiment shown in FIG. 1. Accordingly, the covering surfaces 5 and the passage areas 4 are significantly smaller. An inlet flow element 3 according to this embodiment therefore exposes a significantly smaller area of the perforated plate for the melt to flow through.

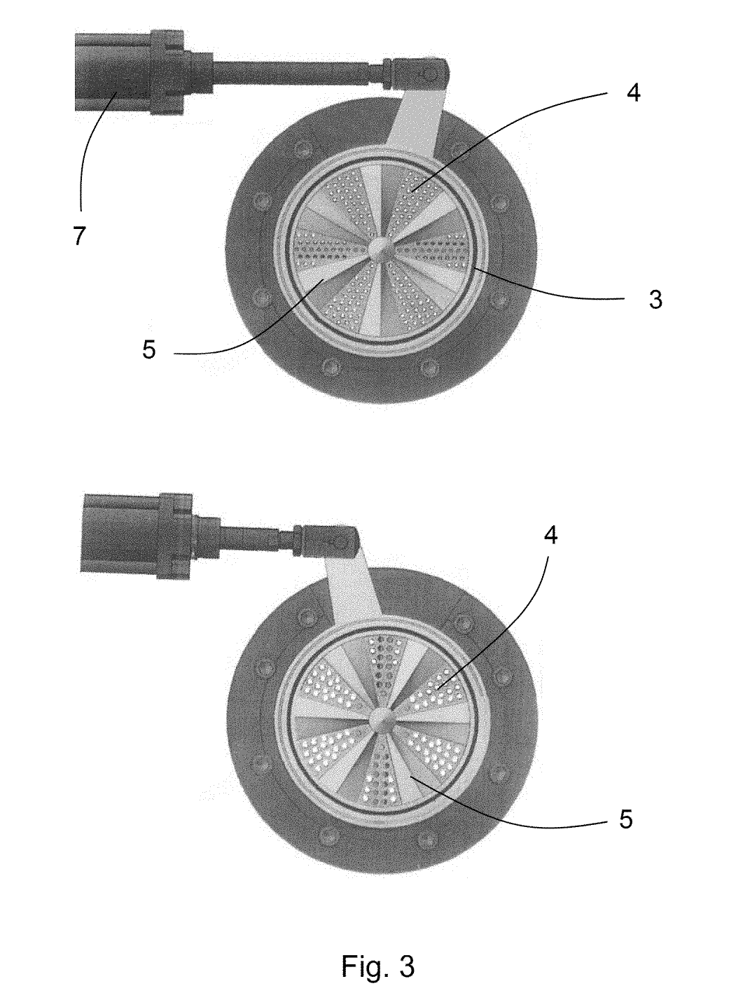

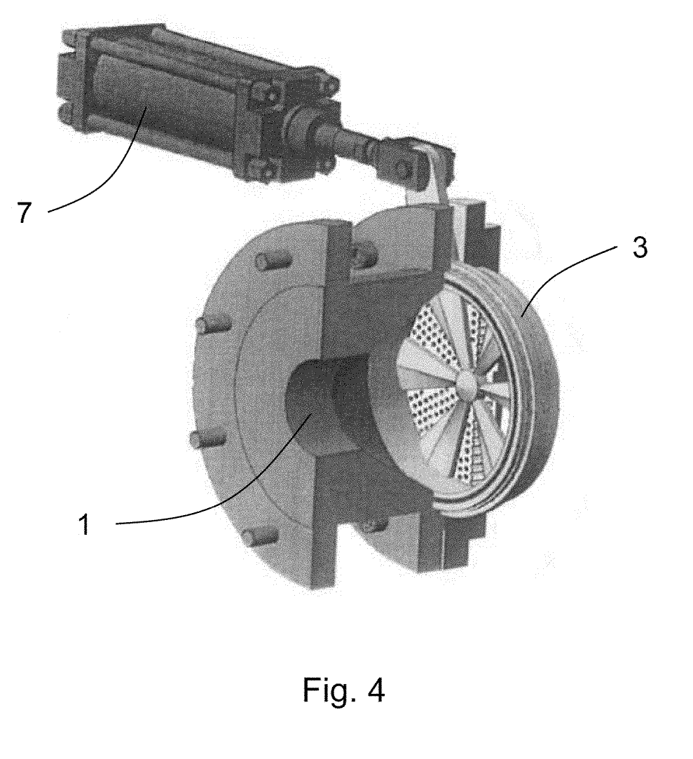

FIG. 3 shows a plan view of an inlet flow element 3 according to the embodiment in FIG. 1 installed in an extruder, viewed in the direction of flow of the melt. The inlet flow element 3 is mounted rotatably in a flange. To move or rotate the inlet flow element 3, said element is connected to an actuator 7. In FIG. 4, the inlet flow element 3 illustrated in FIGS. 1 and 3 is shown partially cut away in the installed state.

The upper depiction in FIG. 3 shows the inlet flow element 3 in a first position, in which there are holes in the perforated plate behind the passage areas 4, with the result that a first subset of holes in the perforated plate is exposed. A second subset of holes in the perforated plate is situated behind the covering surfaces 5 and is thus closed. In the lower depiction in FIG. 3, the inlet flow element 3 has been rotated anticlockwise by 30° relative to the position in the upper depiction. The previously open holes in the perforated plate are now covered by the covering surfaces 5, while the melt can now flow through the previously covered holes.

In the example shown, the holes in the perforated plate are embodied differently in the two subsets. In the subset of holes which is open in the upper depiction, a large number of small holes is arranged. In contrast, fewer but larger holes are arranged in the subset of holes which is open in the lower depiction. The apparatus according to the invention makes it possible to switch between the two sizes of hole without stopping the flow of melt in the extruder, i.e. shutting down the extruder. As a result, it is possible to switch over flexibly between modes of operation without losing running time.

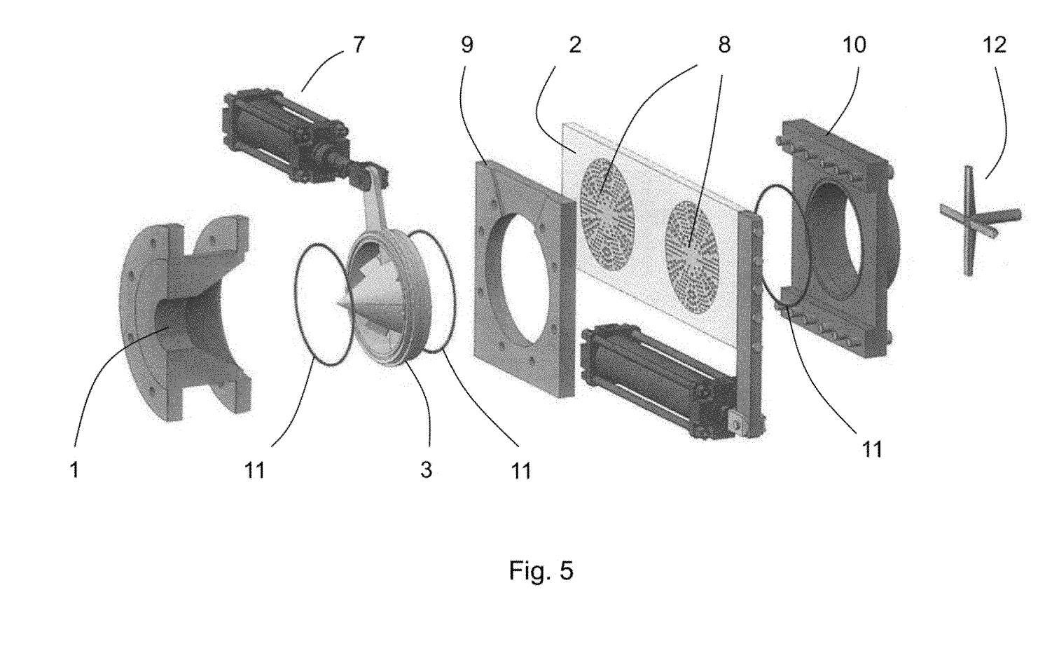

A preferred embodiment of the invention is shown schematically in an exploded view in FIG. 5. Of the extruder, only the extruder outlet is shown. The direction of flow of the melt is from left to right. A first plate 9 and a second plate 10 are flanged to the outlet end of the extruder and connected firmly to the extruder.

Between the upper and lower end, the second plate 10 has an internal recess, in which a perforated plate 2 is movably mounted. The perforated plate 2 comprises two through-flow areas 8, which both contain a multiplicity of through-flow openings. The outer contour of the through-flow areas 8 (envelope around the through-flow openings) is in each case circular and corresponds in cross section to the internal cross section of the flow channel 1 at this point. To move the perforated plate 2, an actuator is provided, which can move the perforated plate substantially perpendicularly to the flow channel 1 by means of a linear motion.

Arranged between the extruder outlet and the first plate 9 is an inlet flow element 3, which can be rotated through a predetermined angle with the aid of an actuator 7. In this example, the inlet flow element 3 corresponds to that shown in FIG. 2. To avoid the melt escaping at an unwanted location, sealing elements 11 are provided between the extruder outlet, the inlet flow element 3, the perforated plate 2 and the second plate 10. A granulating tool 12 is provided at the outlet end of the apparatus, resting on the perforated plate 2 and cutting the melt strands emerging through the through-flow openings into small granules by means of a rotary motion.

1. An extruder, comprising:
a housing having a flow channel for a melt and a perforated plate delimiting the flow channel on an outlet side, wherein an inlet flow element having passage areas and covering surfaces is arranged so as to be movable ahead of the perforated plate in a direction of flow of the melt in such a way that, when the inlet flow element is moved, a first subset of holes in the perforated plate is exposed and a second subset of holes in the perforated plate is closed, and wherein the inlet flow element has an inlet flow cone, a base of which faces in a direction of the perforated plate and which tapers conically counter to the direction of flow of the melt.

2. (canceled)

3. The extruder as claimed in claim 1, wherein the inlet flow element has a circular cross-sectional area, and the movement is accomplished by rotation about a center of the cross-sectional area.

4. The extruder as claimed in claim 1, wherein the covering surfaces extend radially from a center of the inlet flow element to a rim thereof.

5. The extruder as claimed in claim 4, wherein the covering surfaces have a profile in a longitudinal section which has its widest extent at a base thereof facing the perforated plate and tapers counter to the direction of flow of the melt.

6. (canceled)

7. The extruder as claimed in claim 4, wherein the inlet flow element has a circular cross-sectional area, and the movement is accomplished by rotation about a center of the cross-sectional area.

8. The extruder as claimed in claim 1, wherein the covering surfaces are in contact with the perforated plate at least with their edges.

9. The extruder as claimed in claim 1, further comprising an actuator for moving the inlet flow element, at least one sensor for detecting a pressure in the flow channel, and a control module, wherein the control module is configured such that the inlet flow element is moved with the aid of the actuator when a predetermined critical value for a pressure or for a pressure difference is reached.
